(19) United States
(12) Patent Application Publication
(10) Pub. No.: US 2026/0105674 A1
(43) Pub. Date: Apr. 16, 2026

(54) INFORMATION INTERACTION METHOD, APPARATUS, ELECTRONIC DEVICE, AND COMPUTER-READABLE STORAGE MEDIUM

(71) Applicant: METADREAM TECH PTE. LTD., Singapore (SG)

(72) Inventors: Zejia Chen, Singapore (SG); Di Zhang, Singapore (SG); Qinghui Yao, Singapore (SG); Chunhe Wang, Singapore (SG); Haiying Shen, Singapore (SG); Chaoran Xiao, Singapore (SG); Zimodi Yang, Singapore (SG); Ning Liu, Singapore (SG); Liqiang Wang, Singapore (SG)

(21) Appl. No.: 19/299,276

(22) Filed: Aug. 13, 2025

(30) Foreign Application Priority Data
Oct. 12, 2024 (CN) 202411425705.8

(51) Int. Cl. G06T 13/40; G06F 3/04883; G10L 15/18

(52) U.S. Cl. CPC G06T 13/40; G06F 3/04883; G10L 15/1822

(57) ABSTRACT

The present disclosure provides an information interaction method, an apparatus, an electronic device, and a computer-readable storage medium, wherein the method includes: performing a real-time collection of voice information to generate voice collection data in response to a first touch operation on a check-in button; performing semantic recognition on the voice collection data to determine a semantic recognition result of the voice collection data; determining an update strategy for a first virtual character module according to the semantic recognition result; and updating the first virtual character module according to the determined update strategy, so that an update result can be displayed in graphical user interfaces of a first user and other users. Through the method, accuracy, convenience, and diversity of check-in information are enhanced.

### CROSS-REFERENCE TO RELATED APPLICATION

The present disclosure claims priority to Chinese patent application No. 202411425705.8, filed with the Chinese Patent Office on Oct. 12, 2024, the entire contents of which are incorporated herein by reference.

### TECHNICAL FIELD

The present disclosure relates to the field of interactive technology, and particularly to an information interaction method, an apparatus, an electronic device, and a computer-readable storage medium.

### BACKGROUND ART

With the development of technology and the progress of the times, social media provides users with an increasingly rich way to present themselves. Users can post their status through the social media app to allow other users to see and further interact with other users. Users can also interact with other users in various ways through the social media app.

Posting user status through check-in is a major way of presenting personal information in the social media app.

### SUMMARY

In view of this, the objective of the present disclosure is to provide an information interaction method, an apparatus, an electronic device, and a computer-readable storage medium to enhance the accuracy, convenience, and diversity of check-in information.

In a first aspect, the embodiments of the present disclosure provide an information interaction method, wherein at least part of a virtual interaction scene is displayed in a graphical user interface, the virtual interaction scene comprises a first virtual character module controlled by a first user and a second virtual character module controlled by another user, a check-in button is further displayed in the graphical user interface, and the check-in button is floatingly displayed on the virtual interaction scene. The information interaction method includes:
performing real-time collection of voice information to generate voice collection data in response to a first touch operation on a check-in button;
performing semantic recognition on the voice collection data to determine a semantic recognition result of the voice collection data;
determining an update strategy for a first virtual character module according to the semantic recognition result; and
updating the first virtual character module according to the determined update strategy, so that an update result can be displayed in graphical user interfaces of a first user and other users.

In conjunction with the first aspect, the embodiments of the present disclosure provide a first possible implementation of the first aspect, wherein the step of performing real-time collection of voice information to generate voice collection data in response to a first touch operation on a check-in button includes:
starting collection of voice information in response to a press operation on a check-in button; and
ending the collection of the voice information in response to a release operation after the press operation on the check-in button, and taking the voice information acquired after the starting and before the ending as voice collection data.

In conjunction with the first aspect, the embodiments of the present disclosure provide a second possible implementation of the first aspect, wherein the step of performing a real-time collection of voice information to generate voice collection data in response to a first touch operation on a check-in button includes:
starting real-time collection of voice information and performing timing in response to the first touch operation on the check-in button;
ending the collection of the voice information in response to the timing reaching a predetermined duration, and taking the voice information acquired after the starting and before the ending as voice collection data.

In conjunction with the first aspect, the embodiments of the present disclosure provide a third possible implementation of the first aspect, wherein the method further includes:
displaying a virtual character input control in a graphical user interface in response to a second touch operation on the check-in button; and
generating the semantic recognition result in response to a touch operation on the virtual character input control.

In conjunction with the third possible implementation of the first aspect, the embodiments of the present disclosure provide a fourth possible implementation of the first aspect, wherein the step of performing semantic recognition on the voice collection data to determine a semantic recognition result of the voice collection data includes:
performing a first semantic recognition on the voice collection data through a current user terminal;
generating a semantic recognition result of the voice collection data according to a result of the first semantic recognition when the first semantic recognition is successful;
sending the voice collection data to a cloud server for a second semantic recognition when the first semantic recognition fails; and
generating a semantic recognition result of the voice collection data according to a result of the second semantic recognition when the second semantic recognition is successful.

In conjunction with the first aspect, the embodiments of the present disclosure provide a fifth possible implementation of the first aspect, wherein an update strategy of the first virtual character module includes at least one of the following:
an action animation of the first virtual character model, an expression of the first virtual character model, an attire of the first virtual character model, an accessory corresponding to the first virtual character model, a semantic recognition result corresponding to the first virtual character model, a state information of the first virtual character model, and a voice information corresponding to the voice collection data.

In conjunction with the first possible implementation or the second possible implementation of the first aspect, the embodiments of the present disclosure provide a sixth possible implementation of the first aspect, wherein the method further includes:
performing, after starting a real-time collection of voice information, real-time voice recognition on the collected voice information and updating the result of the voice recognition to be displayed in the graphical user interface.

In conjunction with the first aspect, the embodiments of the present disclosure provide a seventh possible implementation of the first aspect, wherein before the step of updating the first virtual character module according to the determined update strategy, the method further includes:
displaying an update strategy to be updated in the graphical user interface; and
adjusting the update strategy to be updated in response to a touch operation by a user on the update strategy to be updated.

In a second aspect, the embodiments of the present disclosure provide an information interaction apparatus, wherein at least part of a virtual interaction scene is displayed in a graphical user interface, the virtual interaction scene comprises a first virtual character module controlled by a first user and a second virtual character module controlled by another user, a check-in button is further displayed in the graphical user interface, and the check-in button is floatingly displayed on the virtual interaction scene. The information interaction apparatus includes:
a collection module, configured for performing real-time collection of voice information to generate voice collection data in response to a first touch operation on a check-in button;
a first recognition module, configured for performing semantic recognition on the voice collection data to determine a semantic recognition result of the voice collection data;
a determination module, configured for determining an update strategy for a first virtual character module according to the semantic recognition result; and
an update module, configured for updating the first virtual character module according to the determined update strategy, so that an update result can be displayed in graphical user interfaces of a first user and other users.

In conjunction with the second aspect, the embodiments of the present disclosure provide a first possible implementation of the second aspect, wherein when performing real-time collection of voice information to generate voice collection data in response to a first touch operation on a check-in button, the collection module is specifically configured for:
starting collection of voice information in response to a press operation on a check-in button; and
ending the collection of the voice information in response to a release operation after the press operation on the check-in button, and taking the voice information acquired after the starting and before the ending as voice collection data.

In conjunction with the second aspect, the embodiments of the present disclosure provide a second possible implementation of the second aspect, wherein when performing a real-time collection of voice information to generate voice collection data in response to a first touch operation on a check-in button, the collection module is specifically configured for:
starting real-time collection of voice information and performing timing in response to the first touch operation on the check-in button;
ending the collection of the voice information in response to the timing reaching a predetermined duration, and taking the voice information acquired after the starting and before the ending as voice collection data.

In conjunction with the second aspect, the embodiments of the present disclosure provide a third possible implementation of the second aspect, wherein the apparatus further includes:
a first display module, configured for displaying a virtual character input control in a graphical user interface in response to a second touch operation on the check-in button; and
a generation module, configured for generating the semantic recognition result in response to a touch operation on the virtual character input control.

In conjunction with the third possible implementation of the second aspect, the embodiments of the present disclosure provide a fourth possible implementation of the second aspect, wherein when performing semantic recognition on the voice collection data to determine a semantic recognition result of the voice collection data, the first recognition module is specifically configured for:
performing a first semantic recognition on the voice collection data through a current user terminal;
generating a semantic recognition result of the voice collection data according to a result of the first semantic recognition when the first semantic recognition is successful;
sending the voice collection data to a cloud server for a second semantic recognition when the first semantic recognition fails; and
generating a semantic recognition result of the voice collection data according to a result of the second semantic recognition when the second semantic recognition is successful.

In conjunction with the second aspect, the embodiments of the present disclosure provide a fifth possible implementation of the second aspect, wherein an update strategy of the first virtual character module includes at least one of following:
an action animation of the first virtual character model, an expression of the first virtual character model, an attire of the first virtual character model, an accessory corresponding to the first virtual character model, a semantic recognition result corresponding to the first virtual character model, a state information of the first virtual character model, and a voice information corresponding to the voice collection data.

In conjunction with the first possible implementation or the second possible implementation of the second aspect, the embodiments of the present disclosure provide a sixth possible implementation of the second aspect, wherein the apparatus further includes:
a second recognition module, configured for performing, after starting a real-time collection of voice information, real-time voice recognition on the collected voice information and updating the result of the voice recognition to be displayed in the graphical user interface.

In conjunction with the second aspect, the embodiments of the present disclosure provide a seventh possible implementation of the second aspect, wherein the apparatus further includes:
a second display module, configured for displaying an update strategy to be updated in the graphical user interface; and
an adjustment module, configured for adjusting the update strategy to be updated in response to a touch operation by a user on the update strategy to be updated.

In a third aspect, an electronic device is provided in the embodiments of the present disclosure, which includes a processor, a memory, and a bus. The memory stores machine-readable instructions that are executed by the processor. The processor communicates with the memory via the bus when the electronic device is in operation. When run by the processor, the machine-readable instructions perform the steps in any possible implementation of the first aspect.

In a fourth aspect, the embodiments of the present disclosure further provide a computer-readable storage medium, wherein the computer readable storage medium stores a computer program. When executed by the processor, the computer program executes the steps in any possible implementation of the first aspect.

The present disclosure provides an information interaction method, an apparatus, an electronic device, and a computer-readable storage medium. When the user performs a check-in, the user can complete the check-in by inputting voice information, so that the update strategy of the first virtual character module can be generated according to the semantic recognition result of the voice input by the user. The information posted during the check-in is not limited to text information, but can also include other relevant information of the virtual character, which enhances the accuracy, convenience, and diversity of the check-in information.

In order to make the above objectives, features, and advantages of the present disclosure more obvious and easier to understand, the following better embodiments, together with the attached drawings, are described in detail as follows.

### BRIEF DESCRIPTION OF DRAWINGS

To more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinary skilled in the art can also obtain other related drawings based on these drawings without inventive effort.

FIG. 1 illustrates a schematic diagram of a graphical user interface of a mobile terminal provided by the embodiment of the present disclosure;

FIG. 2 illustrates a schematic diagram of a content displayed in a graphical user interface when switched to an AR scene, provided by the embodiment of the present disclosure;

FIG. 3 illustrates a flowchart of an information interaction method provided by the embodiment of the present disclosure;

FIG. 4 illustrates a schematic diagram of a background portion in a graphical user interface provided by the embodiment of the present disclosure;

FIG. 5 illustrates a schematic diagram of displaying a semantic recognition result in an AR interface, provided by the embodiment of the present disclosure;

FIG. 6 illustrates a schematic diagram of a complete check-in process provided by the embodiment of the present disclosure;

FIG. 7 illustrates a schematic diagram of displaying a gathered state after a check-in is completed, provided by the embodiment of the present disclosure;

FIG. 8 illustrates a schematic diagram of a structure of an information interaction apparatus provided by the embodiment of the present disclosure; and

FIG. 9 illustrates a schematic diagram of a structure of an electronic device provided by the embodiment of the present disclosure.

### DETAILED DESCRIPTION OF EMBODIMENTS

In order to make the objective, technical solutions, and advantages of the embodiments of the present disclosure clearer, the following description will provide a clear and comprehensive explanation of the technical solutions in the embodiments of the present disclosure with reference to the drawings in the embodiments of the present disclosure. Clearly, the described embodiments are part of the embodiments of the present disclosure and not the entire embodiments. The components of embodiments of the present disclosure which are generally described and illustrated in the drawings herein can be arranged and designed in a variety of different configurations. Accordingly, the following detailed description of the embodiments of the present disclosure provided in the drawings is not intended to limit the scope of the present disclosure for which protection is claimed, but merely represents selected embodiments of the present disclosure. Based on the embodiments in the present disclosure, all other embodiments obtained of those of skill in the art of without making inventive efforts are within the scope of protection of the present disclosure.

With the development of technology, some social media software has introduced more and more products with different dimensions regarding the aspect of “helping users express and present themselves”, which includes text, images, videos, and even more immersive VR/AR interaction methods. Each new expression tool has its unique advantages and corresponding drawbacks.

In related technologies, users typically perform check-ins by posting information about themselves in text form, and in better technologies, check-ins can be accompanied by images, GIFs, or videos. The text portion of the check-in is mainly the text manually input by the user, and images, GIFs, and videos are uploaded by the user from the local device, and after being uploaded, the check-in is complete.

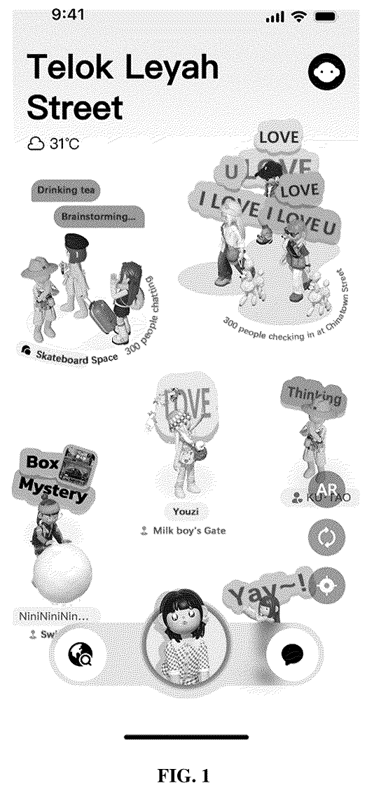

However, the applicant has found that this check-in method is not very accurate and convenient. Based on this, the present disclosure provides an information interaction method. As shown in FIG. 1, it illustrates the graphical user interface of a mobile terminal provided by the present disclosure. At least part of a virtual interaction scene is displayed in a graphical user interface. The virtual interaction scene comprises a first virtual character module controlled by a first user and a second virtual character module controlled by another user. A check-in button is further displayed in the graphical user interface. The check-in button is floatingly displayed on the virtual interaction scene.

The first virtual character module can be a virtual character module named “Youzi” as shown in the figure, and other virtual character modules in the figure are the second virtual character modules controlled by other users. In general, the position of each virtual character module in the virtual interaction scene can be determined based on the real-time position of the virtual character moved by user operation in the virtual interaction scene, or it can be determined based on the position of the user in the real-world scene (i.e., the position of the user in the earth coordinate system).

In the case where the position of the virtual character module in the virtual interaction scene is determined based on the position of the user in the real-world scene, the user needs to activate a positioning function of the mobile terminal (logged into the mobile terminal with a virtual character). The mobile terminal obtains the current position in real time and uploads the position to the server. The server can then update the position of the virtual character controlled by the user in the virtual scene based on the actual positional information of each user in the Earth coordinate system. It can also be said that the position of the virtual character controlled by the user in the virtual scene is a mapping of the user (mobile terminal) in the Earth coordinate system.

The user can slide on the graphical user interface with their finger to adjust the region of the virtual interaction scene displayed in the graphical user interface. The distance and speed of the slide will affect the content displayed in the virtual interaction scene on the graphical user interface. For example, if the user slides to the right with their finger, the content on the left side of the virtual interaction scene in the graphical user interface can be displayed (the entire virtual character modules in FIG. 1 will move to the right).

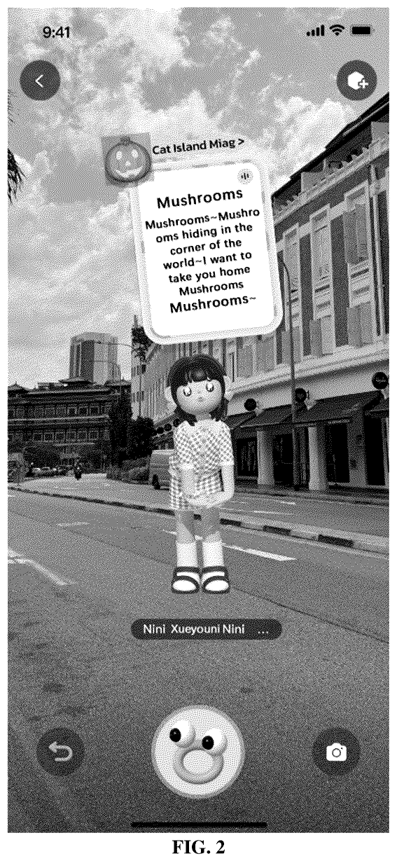

In the graphical user interface, the three buttons at the bottom right are the AR switch button, refresh button, and reposition button. The AR switch button is configured to switch between two virtual interaction scenes (namely, the purely virtual scene and the augmented reality AR scene that are created by the server). As shown in FIG. 2, it illustrates the content displayed in the graphical user interface after switching to the AR scene. In the AR scene interface, the circular button at the lower part is the check-in button. The camera button on the right side of the check-in button is a button configured to trigger the photo-capturing function. The return arrow button on the left side of the check-in button can be a button configured to return to the purely virtual scene. The user can click the camera button to publish the real-time photographed photo as check-in information.

The check-in button in the graphical user interface is located at the lower part in FIG. 1. The circular button in the middle of the button displaying the virtual character is the check-in button that mainly completes the check-in function. The user can trigger the check-in button through operations such as clicking, double-clicking, multiple continuous clicks, or long pressing. The two circular buttons on the left side and the right side of the check-in button are other function buttons. For example, the button on the left side can be a query button, and the button on the right side can be a button configured to publish text information.

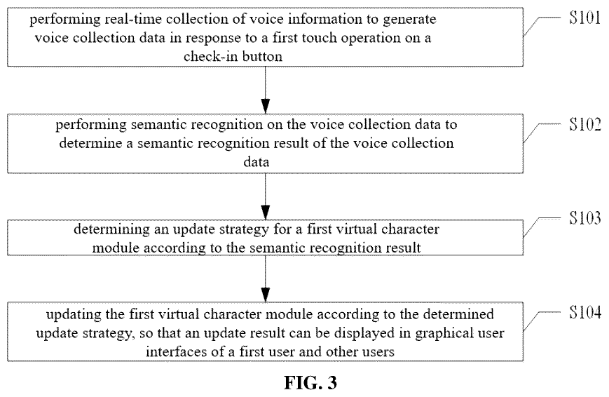

As shown in FIG. 3, the information interaction method includes the following steps:
S101, performing real-time collection of voice information to generate voice collection data in response to a first touch operation on a check-in button;
S102, performing semantic recognition on the voice collection data to determine a semantic recognition result of the voice collection data;
S103, determining an update strategy for a first virtual character module according to the semantic recognition result; and
S104, updating the first virtual character module according to the determined update strategy, so that an update result can be displayed in graphical user interfaces of a first user and other users.

In step S101, the first touch operation has two usage modes, namely, long press for voice input and short press for voice input.

In the case where the long press for voice input is adopted, step S101 can be implemented in the following manner:
starting collection of voice information in response to a press operation on a check-in button; and
ending the collection of the voice information in response to a release operation after the press operation on the check-in button, and taking the voice information acquired after the starting and before the ending as voice collection data.

One pressing operation and one adjacent releasing operation complete one complete long press operation. After the user presses down, voice collection is started (it can be performed through an audio collection device in the mobile terminal, such as a microphone of the mobile phone), and after the user releases, the voice collection is stopped. The voice information collected during the period in which the user long presses the check-in button is taken as the voice collection data.

In the case where the short press for voice input is adopted, step S101 can be implemented in the following manner:
starting real-time collection of voice information and performing timing in response to the first touch operation on the check-in button;
ending the collection of the voice information in response to the timing reaching a predetermined duration, and taking the voice information acquired after the starting and before the ending as voice collection data.

In this case, the user only needs to short press the check-in button once to complete the voice information collection. In a specific implementation, it can be that timing starts from the moment of clicking the check-in button, and timing is stopped when a preset duration is reached. The voice information collected during the time period between the timing start moment and the timing end moment is taken as the voice collection data. Specifically, for example, timing is started by clicking the check-in button, and timing is stopped after 10 seconds, 20 seconds or one minute, and the voice information collection is terminated.

The timing manner can also be implemented in the following manner: timing starts from the moment of clicking the check-in button, and the duration during which no valid voice information is received is calculated in real-time (if the collected voice information does not contain the speaking sound of the user, it is regarded that no valid voice information is received). When the duration during which no valid voice information is received reaches a preset duration, the timing is stopped, and the voice information collection is stopped. Specifically, for example, 5 seconds after pressing the check-in button, the user stops speaking. At the 7th second, the system finds that no valid voice information has been received for 2 seconds, and then the timing can be stopped and the voice information collection can be stopped (2 seconds is the time duration for which no valid voice information is received and the preset duration is reached).

In addition to using voice for input, the check-in button can also be triggered to perform text input (usually, a single click is used for text input).

In the case of triggering for text input, the above method can further include the following steps:
displaying a virtual character input control in a graphical user interface in response to a second touch operation on the check-in button; and
generating the semantic recognition result in response to a touch operation on the virtual character input control.

The second touch operation is usually a single click operation, and can also be a double click or multiple clicks or other touch manners to trigger text input (such as sliding or triggering a designated gesture pattern).

After the user performs the second touch operation, a virtual character input control (soft keyboard) is displayed in the graphical user interface. Thereafter, the user can input through the virtual character input control to complete the text information input. Furthermore, the text information input by the user can be directly used as the semantic recognition result to further perform message publishing in subsequent steps.

In step S102, the performed recognition is semantic recognition, not voice recognition, which is one of the main features in the present solution. Voice recognition can only convert the voice content input by the user into text, but semantic recognition can recognize the emotional information of the input voice of the user, such as the user being in a frustrated state, happy state, and so on. These pieces of state information cannot be represented merely through voice recognition. When performing semantic recognition, it is preferred to use a local model to perform the semantic recognition. However, due to the limited size of the semantic recognition model used in the mobile terminal (mainly due to the insufficient computing power of the mobile terminal), the recognition precision and accuracy are both limited. Therefore, a dual recognition manner can be adopted, that is, recognition is first performed through a small semantic recognition model inside the mobile terminal, and if the recognition result is not ideal, recognition is then performed through a large semantic recognition model in the server, so as to ensure the efficiency and accuracy of recognition.

In other words, step S102 can be implemented in the following manner:
step 1021, performing a first semantic recognition on the voice collection data through a current user terminal;
step 1022, generating a semantic recognition result of the voice collection data according to a result of the first semantic recognition when the first semantic recognition is successful;
step 1023, sending the voice collection data to a cloud server for a second semantic recognition when the first semantic recognition fails; and
step 1024, generating a semantic recognition result of the voice collection data according to a result of the second semantic recognition when the second semantic recognition is successful.

In step 1021, that is, the first semantic recognition is performed by the mobile terminal, and the model used for the first semantic recognition is a small model stored in the mobile terminal.

If the result of the first semantic recognition is not ideal, then in step 1023, the voice collection data can be sent to the server, and recognition is performed by a large semantic recognition model in the server. If the result of the first semantic recognition is relatively ideal, the result of the first semantic recognition can be directly output. Correspondingly, if the result of the second semantic recognition is successful, the result of the second semantic recognition can be directly used as the semantic recognition result of the voice collection data.

It should be noted that, whether the model used for the first semantic recognition (first semantic recognition model) or the model used for the second semantic recognition (second semantic recognition model), the training is completed before use. During use, it only needs to input the voice collection data into the first semantic recognition model or the second semantic recognition model, and the corresponding semantic recognition model can directly output the semantic recognition result.

The computing power required to run the first semantic recognition model is less than the computing power required to run the second semantic recognition model, or the space occupied by the first semantic recognition model is less than the space occupied by the second semantic recognition model.

If the second semantic recognition fails, a prompt message indicating failure of the current semantic recognition can be directly fed back to the user. The prompt message can be displayed in the form of text in the graphical user interface or can prompt the user by voice or in other forms.

Generally, whether the first semantic recognition fails or the second semantic recognition fails, the possible reasons can be the same or different, and overall can be divided into two types. The first type is that there is too little valid voice information, and the second type is that it is impossible to analyze a semantic result. For the first case, most of the reasons are due to the voice of the user being too low or the environment being noisy, which causes the model to fail to effectively extract the voice information, resulting in recognition failure. For the second case, most of the reasons are that the voice duration is particularly short, or there are illogical parts in the voice content.

Therefore, for the above two situations, in the solution provided by the present disclosure, a data validity recognition can be performed before the first semantic recognition or before sending the voice collection data to the cloud server. The validity recognition can include: signal-to-noise ratio judgment, valid voice duration judgment, and the like. If a specified judgment in these judgments fails, a prompt message indicating failure of voice recognition and requesting the user to re-enter the voice can be directly fed back to the user. Generally, if the signal-to-noise ratio is too low, it indicates that the noise content is too high. In this case, even if denoising processing is performed, the obtained result is still difficult to semantically recognize, so a prompt message requesting the user to re-enter the voice can be directly returned to the user. If the valid voice duration is too short, a prompt message requesting the user to re-enter the voice can also be directly returned to the user.

Further, when generating the semantic recognition result, in addition to relying only on the voice information input by the user and the corresponding semantic recognition result, the semantic recognition can also be performed in combination with other information of the user. The information that can be relied on can also include the reference information of the user, specifically, such as the positional information of the user, the image published by the user, the environmental information of the region where the user is located, the identity information of the user, and the like. The reason why these kinds of information can be used to assist in generating the semantic recognition result is mainly considering that these kinds of information can also carry information expressing the ideas of the user. For example, through the positional information of the user, the place where the user is currently located can be learned. The information expressed by the user in different places is inevitably different. In specific types of places, the information expressed by the user is also regular. For example, in tourist places, the information expressed by the user is more likely to be messages related to relaxation or promotion regarding tourism. In working places, the information expressed is more related to work. Similarly, the image published by the user (the image published by the user during check-in) can also carry similar directional information. For example, if the image published during check-in is related to a workplace, the voice information published is mostly related to work. The environmental information can include weather conditions, time information, physical conditions of the user, and the like. These pieces of information can also reflect what the user is thinking and thus are all conducive to the generation of the semantic recognition result.

Similarly, the above types of information also have a complementary effect. For example, if the time information shows that it is relatively late on a working day, and the published image and/or the location indicate that the user is at a working place, it can be determined that the user is in an overtime working state. In this case, it can be determined that the user is working overtime at the company at night, and therefore, the semantic recognition result can be generated toward the direction of working overtime at the company at night.

That is, in the solution provided by the present disclosure, the step of generating the semantic recognition result of the voice collection data according to the result of the first semantic recognition can be performed in the following manner:
generating the semantic recognition result of the voice collection data according to the result of the first semantic recognition and the reference information of the user. The reference information of the user includes at least one of the following: the positional information of the user, the image published by the user, and the environmental information of the region where the user is located.

Correspondingly, in the solution provided by the present disclosure, the step of generating the semantic recognition result of the voice collection data according to the result of the first semantic recognition can be performed in the following manner:
generating the semantic recognition result of the voice collection data according to the result of the second semantic recognition and the reference information of the user. The reference information of the user includes at least one of the following: the positional information of the user, the image published by the user, and the environmental information of the region where the user is located.

In addition to being capable of providing the above-mentioned functions, the positional information of the user is recorded by the system after each check-in. Therefore, the system can form a footprint map for recording the places the user has been to, and the user can also actively check the footprint map.

In order to fully express the semantic recognition result, in the solution provided by the present disclosure, multiple different expression manners are provided for the first virtual character module, that is, the update strategy of the first virtual character module includes at least one of the following:
an action animation of the first virtual character model, an expression of the first virtual character model, an attire of the first virtual character model, an accessory corresponding to the first virtual character model, a semantic recognition result corresponding to the first virtual character model, and a state information of the first virtual character model.

The animation action of the first virtual character model refers to the body actions that the first virtual character can perform, such as raising the hand, yawning, running, and the like. These actions also correspond to the semantic recognition result. For example, if the voice collection data shows that the user is expressing content related to exercise, and the semantic recognition result indicates that the user is panting heavily, it can be determined that the user is undergoing intense exercise. Then the animation action of the first virtual character model can be running or some specific kind of exercise (where the specific kind of exercise can be determined according to the semantic recognition result).

The expression of the first virtual character model is mainly used to reflect the emotional information in the semantic recognition result, which is also a main difference between semantic recognition and voice recognition. Through semantic recognition, the current emotional state of the user can be recognized. For example, if the user is currently saying “I am very happy” but the tone is very gloomy, then a forced smile expression can be used as the expression of the first virtual character model.

The clothing of the first virtual character model mainly refers to the clothes that affect the appearance of the virtual character. The accessories corresponding to the first virtual character model refer to items worn on the body and pets being held and the like. In addition to clothing, these are non-character objects for displaying the status of the user.

The clothing can also be generated based on the semantic recognition result. In addition to being generated through the semantic recognition result, the clothing can also be generated based on the aforementioned reference information of the user. For example, if the positional information of the user shows that the user is at the beach, then the virtual character can be dressed in beachwear; if it shows that the user is near a company, then the virtual character can be dressed in a suit. If the environmental information shows that the user is in the rain or outdoors during the rain, an umbrella can be used as an accessory. If the image published by the user shows that the user is at a barbecue stall, then skewers and casual clothes can be configured for the virtual character. If the location of the user shows that the user is in a residential community and after work time, and a dog barking sound can be detected in the semantic recognition result, then home wear and a dog can be configured for the user to indicate that the user is in a dog-walking state.

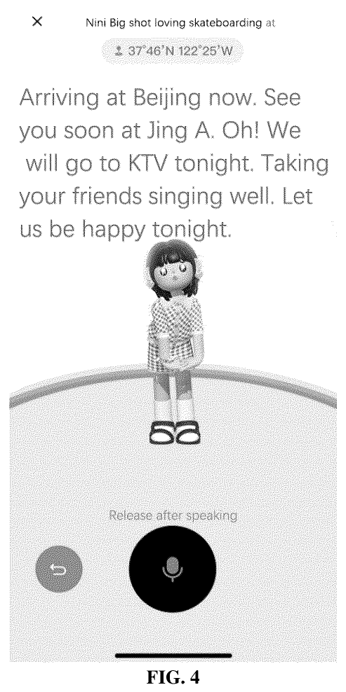

The semantic recognition result corresponding to the first virtual character model is mainly displayed in the form of characters, which are divided into two types: text and symbols. The text is relatively simple, which is the text content in the semantic recognition result. The symbols can display the emotional state of the voice sent by the user. For example, if the user is excited, more exclamation marks can be used; if the user is questioning, question marks can be used. Further, if the identity of the user is a person who likes rock music, the semantic recognition result can be displayed through special rock-style characters. As shown in FIG. 2, the characters such as “mushroom mushroom” above the head of the virtual character are a form of displaying the semantic recognition result. If the time shows that it is currently Halloween or the current location of the user is related to Halloween, then a pumpkin head for Halloween can be displayed in the image. As shown in FIG. 5, what is displayed is a form of displaying the semantic recognition result in the AR interface.

The status information of the first virtual character model is the status information published by the user. In the status information, the users can display their current status. As shown in FIG. 1, the word “love” above the head of “Youzi” is the status information. Among the three people in the upper left corner of “Youzi”, “Drinking tea” is the status information.

The voice information corresponding to the voice collection data is actually the sound made by the user. The sound can be the original recorded sound, the denoised original sound, or a virtual sound (such as a cartoon voice) obtained by playing the text content after performing semantic recognition/voice recognition on the sound sent by the user through a specific virtual sound effect. It can also be a virtual sound played using the timbre information obtained after determining the timbre information based on the sound sent by the user.

It should be noted that the above update strategy is generally automatically output by a trained model, that is, the model can automatically output the update strategy according to the semantic recognition result.

After determining the update strategy, the step S104 of updating the first virtual character module according to the determined update strategy, so that an update result can be displayed in graphical user interfaces of a first user and other users, can be executed.

After the update is completed, the update result is directly displayed in the graphical user interface of the first user (where the refresh is automatically completed), and other users need to complete a refresh through a timed refresh, manual refresh, or other refresh manners, so as to be able to see the updated result of the first virtual character module of the first user.

Generally, the objective of the user performing the update is to display his or her own information. Therefore, after the first user completes the check-in (performs step S104), the surrounding virtual characters can be gathered so that the user can see the status of other users (see the virtual character status controlled by other users in the graphical user interface), thereby enhancing the interactivity.

Further, in order to improve the interaction efficiency of the user, after performing step S104, the solution of the present disclosure can further include the following steps:
according to the content of the update strategy, querying second virtual character modules nearby that are similar to the updated first virtual character module as target virtual character modules; and
prominently displaying the target virtual character modules in the current graphical user interface.

Finding other second virtual character modules of the same type enables the first user to know who else is similar to himself or herself (where similar users are more likely to interact with each other). For example, users who are both in an overtime status or users who are both in a dining status are more likely to communicate. In fact, the update strategy and the semantic recognition result have a certain mapping relationship. Therefore, in this step, using the semantic recognition result or the update strategy to perform the query is equivalent.

Specifically, the similarity between the second virtual character module and the first virtual character module can be calculated directly by comparison based on various information in the update strategy or the semantic recognition result.

There are two manners of prominent display. One is to prominently display the target virtual character modules without hiding non-target virtual character modules (for example, through highlighting, zooming, and other manners); the second is to hide the second virtual character modules that are non-target virtual character modules, so that the user can only see the target virtual character modules that are similar to himself or herself. In the case of prominent display, a clustered display manner can be adopted to improve the viewing efficiency of the user. Specifically, the number of target virtual character modules displayed in the graphical user interface can be guaranteed to reach a predetermined number by zooming in or out the virtual interaction scene space displayed in the graphical user interface.

In order to enable the user to clearly understand what he or she is saying, the solution provided by the present disclosure further includes the following content:
performing, after starting a real-time collection of voice information, real-time voice recognition on the collected voice information and updating the result of the voice recognition to be displayed in the graphical user interface.

As shown in FIG. 4, the background part in the graphical user interface is the text currently input by the user. By displaying this text, the user can know what he or she has said and can understand what content has not yet been finished, thereby facilitating the user to determine what needs to be spoken next. The “37° 46′N 122°25W” above the text in the graphical user interface is the current latitude and longitude information of the user.

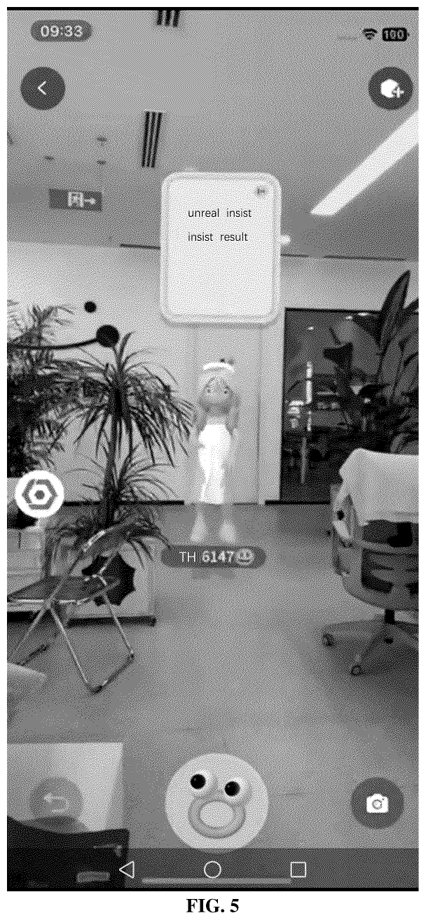

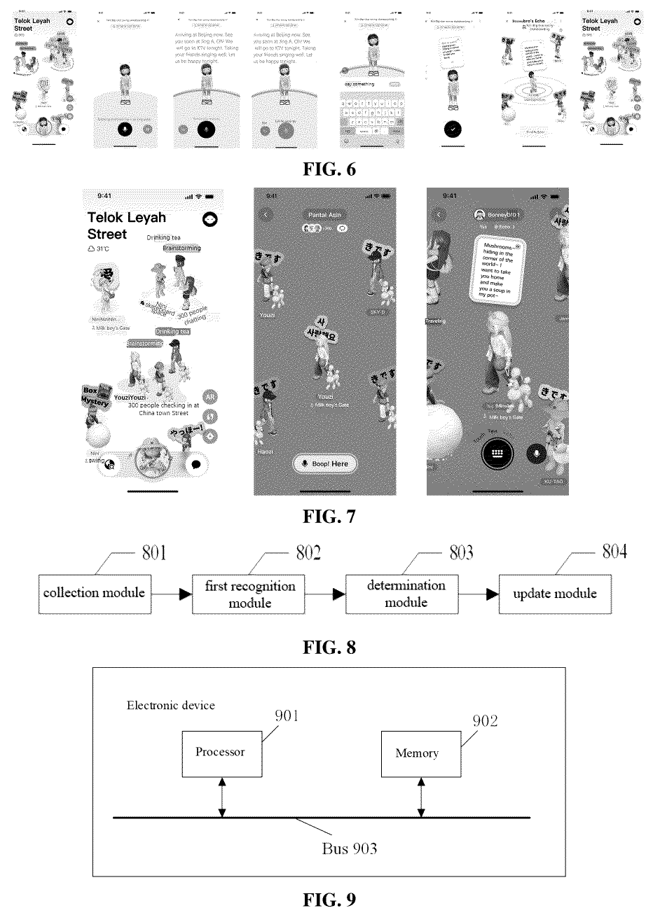

As shown in FIG. 6, a complete process of performing a check-in is shown. In the first image of FIG. 6, the status in the graphical user interface before the user triggers the check-in button is displayed. In this image, the first virtual character module controlled by the first user is a virtual character module named “Youzi”, and all other virtual character modules around Youzi are second virtual character modules. In the image, the circular button with a cartoon character at the bottom is the check-in button.

After the user clicks the check-in button, it jumps to the second image in FIG. 6. In this image, the user has not yet long-pressed the speech button (the circular button with a microphone icon at the bottom of the image) to start speaking. Therefore, no text content is displayed on the background panel. After the user starts speaking, it jumps to the third image. The background displays the text content corresponding to what the user is currently saying. The fourth image corresponds to the state where the user has completed speaking. The user has clicked the undo button on the left side of the speech button but has not raised the hand. The fifth image shows that the user corrects the spoken text content just now or re-inputs the text content to be checked in through manual text input. The seventh image shows the status of the check-in information before publishing, that is, before publishing, a confirmation is performed for the user. In this process, any content in the update strategy can be adjusted. After the confirmation, it proceeds to the content shown in the eighth image, that is, the first virtual character module is updated according to the update strategy. At this time, an animation effect is first displayed. Since the image is static, only a screenshot of one frame of the animation effect can be displayed. In the animation, the first virtual character module is in a singing and dancing state, and the surrounding target virtual character modules are also prominently displayed (where the second virtual character modules that are non-target virtual character modules are hidden). The content shown in the ninth image is the state after the animation has been played, and overall, it has returned to the state in the first image (where only the content updated according to the update strategy is retained).

As shown in FIG. 7, the gathered state after the check-in is completed is displayed. The first image in FIG. 7 is an image example before performing the check-in (interface before executing step S101), and the second and third images show the schematic diagram of interface change before and after executing step S104. It can be seen that in the third image, the second virtual character modules displayed in the graphical user interface have undergone obvious changes compared with the virtual character modules in the second image, that is, filtering has been performed. Meanwhile, in the third image, the displayed region is also zoomed in.

Overall, the solution provided by the present disclosure has the following characteristics.

From the perspective of the manner of expression, the function of the present solution retains the advantages of traditional expression tools in terms of text and image expression, and at the same time increases the weight of expression in the voice dimension, thereby increasing sufficient interest. When the user performs expression, there are both the basic advantages of text and image, and also newer experiences and expressions, allowing quick “voice”, real-time “speech”, and expression of oneself in a more natural and direct manner.

From the perspective of the expression result, the function of the present solution breaks through the what-you-see-is-what-you-get experience of the user. Compared with the traditional expression tools that commonly use filters, background music, or special effects, the present solution uses a more vivid processing manner—rich emotions and actions of the avatar. According to the content of expression, the avatar of the user can have different reactions, including emotional and action changes, more truly and directly mapping the expression of the user to the avatar, making the avatar more vivid and expressive on behalf of the user, and at the same time, with the voice input by the user, making the avatar not deviate from the real self. The vivid performance after intelligent analysis combined with the real and direct voice of the user forms the unique result of the expression tool of the present solution.

There are supplement of functional uniqueness as follows.

Unique action performance: In the present solution, from small emotional expressions such as facial expressions and lip shapes to large-scale auxiliary expressions such as actions and props, all have unique performance manners. It is not a direct copy of the emotions or actions that users would perform in real life, but a processed expression, which is more exaggerated, more surreal, wittier, or more humorous in the presentation manner. For example, user voice input “ [symbol] ” (pronunciation being “wofule”) in Chinese (meaning I am fed up) is a frequently occurring case in the current daily expression of many users. In the function of the present solution, the similar presentation manner is “ [symbol] ” (pronunciation being “wofule”) in Chinese (meaning I am floating), the entire virtual character model will float up, and the scattered items around will also float up together, phonetically expressing this mindset of “ [symbol] ” (pronunciation being “wofule”) in Chinese (meaning I am fed up), and the image presented is also a kind of feeling of “out of control and helplessness”.

Unique understanding and analysis: in the expression style of the present solution, the user does not need to manually select the corresponding action, but only needs to simply speak or type, and according to the expression of the user, the present solution will select the emotion and action that match the corresponding mindset of the user. In this regard, how to accurately understand the content that the user intends to express is a unique manner of the function of the present solution. According to the tone, context, environment, time, or even location, a comprehensive judgment is made on the content currently expressed by the user, allowing the user to have an expression experience of “yes, this is exactly how I would react”.

Overall, the solution provided by the present disclosure also has the following values.

1. Tool Value: a simple and direct, operation-rich, accurate and vivid, and effect-rich expression tool.

Simple and direct: the user only needs to speak a sentence or type a paragraph to complete the expression, and a Bondee performance can be quickly generated.

Operation-rich: in each expression, the user can at any time adjust their voice effect, change the action of their avatar, modify the graphic and text description, and even customize the expression of props.

Accurate and vivid: by understanding the tone and context of the user, and combining the time/location of the user, the expression content of the user is fully analyzed, and the emotion and action that best match the expression content of the user are selected.

Effect-rich: the basic effects of traditional graphic and text expression tools are provided, as well as the 3D and dynamic performance of avatars, and the addition of voice expression, thereby forming a rich expression effect in both vision and hearing.

2. Emotional value: discovering other users similar to the user.

Understanding you: each “Boop!” expression of the user will be recorded in the app. In the continuous expression process, the “Boop!” tool will increasingly understand the terms, expression manner, and commonly used tone of the user, thereby selecting emotions and actions more suitable for the expression of the user. Allowing each person to be unique, understanding various styles such as extroverted and introverted persons, trendy, street, home, y2k, etc.

Recording you: each “Boop!” will be stored in a footprint map in the app, and the location of each “Boop!” of the user will be recorded on the map, thus allowing the user to review their thoughts at a certain time and place at any time. It can also be managed and adjusted, thereby truly recording every self of the user at different times and different places.

Connecting more “you” similar to you: in the final stage of “Boop!”, if there are “Boop!” with similar content around, these persons will also appear around the user, just like an echo “Echo”, and after each “Boop!” the user will be connected to every Echo similar to them, thereby resonating with others.

3. Social and community value: a community atmosphere of reality, interest, and warm resonance.

Reality: the text, image, and sound of the user during “Boop!” are unique and real, and the location that appears during “Boop!” is also unique and real. Each real “Boop!” constitutes a real Bondee.

Interest: the emotion and action during each “Boop!” are ever-changing, and with the unique clothing matching of each person, the “Boop!” content of the entire Bondee appears interesting and unique.

Warm resonance: each “Boop!” will be accompanied by a unique Echo. Avatars who “Boop!” in the same location range will also gather together, making it appear lively and warm.

Based on the same technical concept, an embodiment of the present disclosure also provides an information interaction apparatus. At least part of a virtual interaction scene is displayed in a graphical user interface. The virtual interaction scene comprises a first virtual character module controlled by a first user and a second virtual character module controlled by another user. A check-in button is further displayed in the graphical user interface. The check-in button is floatingly displayed on the virtual interaction scene. As shown in FIG. 8, the apparatus includes:
a collection module 801, configured for performing real-time collection of voice information to generate voice collection data in response to a first touch operation on a check-in button;
a first recognition module 802, configured for performing semantic recognition on the voice collection data to determine a semantic recognition result of the voice collection data;
a determination module 803, configured for determining an update strategy for a first virtual character module according to the semantic recognition result; and
an update module 804, configured for updating the first virtual character module according to the determined update strategy, so that an update result can be displayed in graphical user interfaces of a first user and other users.

Optionally, when performing a real-time collection of voice information to generate voice collection data in response to a first touch operation on a check-in button, the collection module 801 is specifically configured for:
starting collection of voice information in response to a press operation on a check-in button; and
ending the collection of the voice information in response to a release operation after the press operation on the check-in button, and taking the voice information acquired after the starting and before the ending as voice collection data.

Optionally, when performing a real-time collection of voice information to generate voice collection data in response to a first touch operation on a check-in button, the collection module 801 is specifically configured for:
starting real-time collection of voice information and performing timing in response to the first touch operation on the check-in button;
ending the collection of the voice information in response to the timing reaching a predetermined duration, and taking the voice information acquired after the starting and before the ending as voice collection data.

Optionally, the apparatus further includes:
a first display module, configured for displaying a virtual character input control in a graphical user interface in response to a second touch operation on the check-in button; and
a generation module, configured for generating the semantic recognition result in response to a touch operation on the virtual character input control.

Optionally, when performing semantic recognition on the voice collection data to determine a semantic recognition result of the voice collection data, the first recognition module is specifically configured for:
performing a first semantic recognition on the voice collection data through a current user terminal;
generating a semantic recognition result of the voice collection data according to a result of the first semantic recognition when the first semantic recognition is successful;
sending the voice collection data to a cloud server for a second semantic recognition when the first semantic recognition fails; and
generating a semantic recognition result of the voice collection data according to a result of the second semantic recognition when the second semantic recognition is successful.

Optionally, an update strategy of the first virtual character module includes at least one of following:
an action animation of the first virtual character model, an expression of the first virtual character model, an attire of the first virtual character model, an accessory corresponding to the first virtual character model, a semantic recognition result corresponding to the first virtual character model, a state information of the first virtual character model, and a voice information corresponding to the voice collection data.

Optionally, the apparatus further includes:
a second recognition module, configured for performing, after starting a real-time collection of voice information, real-time voice recognition on the collected voice information and updating the result of the voice recognition to be displayed in the graphical user interface.

Optionally, the apparatus further includes:
a second display module, configured for displaying an update strategy to be updated in the graphical user interface; and
an adjustment module, configured for adjusting the update strategy to be updated in response to a touch operation by a user on the update strategy to be updated.

FIG. 9 is a schematic diagram of the structure of an electronic device provided by the embodiment of the present disclosure. The electronic device includes: a processor 901, a memory 902, and a bus 903, wherein the memory 902 stores machine-readable instructions executable by the processor 901. When the electronic device runs the above information processing method, the processor 901 communicates with the memory 902 via the bus 903, and the processor 901 executes the machine-readable instructions to perform the steps of the method described in the embodiment.

The embodiment of the present disclosure further provides a computer-readable storage medium, wherein a computer program is stored on the computer-readable storage medium, and the computer program, when executed by a processor, performs the steps of the method described in the embodiment.

It is clearly understood by those skilled in the field to which it belongs that, for the convenience and brevity of the description, the specific working process of the apparatus, electronic device, and computer-readable storage medium described above can be referred to the corresponding process in the preceding method embodiments, and will not be repeated herein.

In the several embodiments provided in the present disclosure, it should be understood that the method, apparatus, electronic device, and computer-readable storage medium that are disclosed can be implemented in other ways. The above-described embodiments of the device are merely schematic. For example, the division of the modules described, which is only a logical functional division, can be divided in another way when actually implemented; and for another example, multiple modules or components can be combined or integrated into another system, or some features can be ignored or not implemented. On another point, the mutual coupling or direct coupling, or communication connection shown or discussed herein can be an indirect coupling or communication connection through communication interfaces, devices, or modules, which can be electrical, mechanical, or other forms.

The units described as separate components may or may not be physically separate, and the components displayed as units may or may not be physical units, meaning they can be located in one place or distributed across multiple network units. Some or all of the units can be selected as needed to achieve the objectives of the embodiments of the present disclosure.

Further, each functional unit in each embodiment of the present disclosure can be integrated into a single processing unit, each unit can be physically present separately, or two or more units can be integrated into a unit.

When the functions are implemented as software functional units and sold or used as independent products, they can be stored in a processor-executable, non-volatile, computer-readable storage medium. Based on this understanding, the technical solution of the present disclosure can essentially be embodied in the form of a software product, which contributes to or includes parts in the prior art. The software product is stored in a storage medium and includes multiple instructions for causing a computer device (which can be a personal computer, server, network device, etc.) to execute all or some of the steps of the methods described in various embodiments of the present disclosure. The aforementioned storage media include various media that can store program code, such as USB drives, external hard drives, read-only memory (ROM), random access memory (RAM), disks, or optical discs.

Finally, it should be noted that the above-described embodiments are only specific embodiments of the present disclosure to illustrate the technical solutions of the present disclosure, and not to limit them. The scope of protection of the present disclosure is not limited thereto. Although the present disclosure is described in detail with reference to the foregoing embodiments, it should be understood by those of ordinary skill in the art that any person skilled in the art can still make modifications or easily envisage variations to the technical solutions described in the aforementioned embodiments within the technical scope disclosed by the present disclosure. Or, some technical features can be equivalently substituted. These modifications, changes, or substitutions do not depart from the essence of the technical solutions of the embodiments of the present disclosure and its scope. All these should be encompassed within the scope of protection of the present disclosure. Therefore, the scope of protection of the present disclosure shall be stated to be subject to the scope of protection of the claims.

What is claimed is:

1. An information interaction method, wherein at least part of a virtual interaction scene is displayed in a graphical user interface, the virtual interaction scene comprises a first virtual character module controlled by a first user and a second virtual character module controlled by another user, a check-in button is further displayed in the graphical user interface, and the check-in button is floatingly displayed on the virtual interaction scene; and the information interaction method comprises:
performing real-time collection of voice information to generate voice collection data in response to a first touch operation on the check-in button;
performing semantic recognition on the voice collection data to determine a semantic recognition result of the voice collection data;
determining an update strategy for the first virtual character module according to the semantic recognition result; and
updating the first virtual character module according to the determined update strategy, so that an update result can be displayed in graphical user interfaces of the first user and other users.

2. The method according to claim 1, wherein the step of performing real-time collection of voice information to generate voice collection data in response to a first touch operation on the check-in button comprises:
starting the collection of voice information in response to a press operation on the check-in button; and
ending the collection of voice information in response to a release operation after the press operation on the check-in button, and taking voice information acquired after the starting and before the ending as the voice collection data.

3. The method according to claim 1, wherein the step of performing real-time collection of voice information to generate voice collection data in response to a first touch operation on the check-in button comprises:
starting the real-time collection of voice information and performing timing in response to the first touch operation on the check-in button; and
ending the collection of voice information in response to the timing reaching a predetermined duration, and taking voice information acquired after the starting and before the ending as the voice collection data.

4. The method according to claim 1, wherein the method further comprises:
displaying a virtual character input control in a graphical user interface in response to a second touch operation on the check-in button; and
generating the semantic recognition result in response to a touch operation on the virtual character input control.

5. The method according to claim 4, wherein the step of performing semantic recognition on the voice collection data to determine a semantic recognition result of the voice collection data comprises:
performing a first semantic recognition on the voice collection data through a current user terminal;
generating the semantic recognition result of the voice collection data according to a result of the first semantic recognition when the first semantic recognition is successful;
sending the voice collection data to a cloud server for a second semantic recognition when the first semantic recognition fails; and
generating the semantic recognition result of the voice collection data according to a result of the second semantic recognition when the second semantic recognition is successful.

6. The method according to claim 1, wherein an update strategy of the first virtual character module comprises at least one of:
an action animation of the first virtual character model, an expression of the first virtual character model, an attire of the first virtual character model, an accessory corresponding to the first virtual character model, a semantic recognition result corresponding to the first virtual character model, a state information of the first virtual character model, and a voice information corresponding to the voice collection data.

7. The method according to claim 2, further comprising:
performing, after starting the real-time collection of voice information, real-time voice recognition on the collected voice information and updating a result of the voice recognition to be displayed in the graphical user interface.

8. The method according to claim 1, wherein before the step of updating the first virtual character module according to the determined update strategy, the method further comprises:
displaying an update strategy to be updated in the graphical user interface; and
adjusting the update strategy to be updated in response to a touch operation by a user on the update strategy to be updated.

9. An information interaction apparatus, wherein at least part of a virtual interaction scene is displayed in a graphical user interface, the virtual interaction scene comprises a first virtual character module controlled by a first user and a second virtual character module controlled by another user, a check-in button is further displayed in the graphical user interface, and the check-in button is floatingly displayed on the virtual interaction scene; and the information interaction apparatus comprises:
a collection module, configured for performing real-time collection of voice information to generate voice collection data in response to a first touch operation on the check-in button;
a first recognition module, configured for performing semantic recognition on the voice collection data to determine a semantic recognition result of the voice collection data;
a determination module, configured for determining an update strategy for a first virtual character module according to the semantic recognition result; and
an update module, configured for updating the first virtual character module according to the determined update strategy, so that an update result can be displayed in graphical user interfaces of a first user and other users.

10. An electronic device, comprising a processor, a memory, and a bus, wherein the memory stores machine-readable instructions that are executed by the processor, the processor communicates with the memory via the bus when the electronic device is in operation, and the machine-readable instructions execute the steps of the method according to claim 1 when executed by the processor.

11. A computer-readable storage medium, wherein the computer-readable storage medium stores a computer program thereon, and when run by a processor, the computer program executes the steps of the method according to claim 1.

12. The method according to claim 3, further comprising:
performing, after starting the real-time collection of voice information, real-time voice recognition on the collected voice information and updating a result of the voice recognition to be displayed in the graphical user interface.
